(19) United States
(12) Patent Application Publication
(10) Pub. No.: US 2024/0052809 A1
(43) Pub. Date: Feb. 15, 2024

(54) FLOATABLE WIND TURBINE FOR PRODUCING HYDROGEN

(71) Applicant: FREW HOLDING B.V., ROTTERDAM (NL)

(72) Inventor: Jamie John Russell FREW, ROTTERDAM (NL)

(21) Appl. No.: 18/547,267

(22) PCT Filed: Feb. 24, 2022
(86) PCT No.: PCT/NL2022/050107

§ 371 Date: Aug. 21, 2023

(30) Foreign Application Priority Data
Feb. 26, 2021 (NL) 2027667

(51) Int. Cl. F03D 13/25; F03D 9/19

(52) U.S. Cl. CPC F03D 13/256; F03D 9/19; F05B 2240/93; F05B 2240/95

(57) ABSTRACT

The invention relates to a floatable wind turbine (1), comprising:
a rotor (2),
a generator (3) driven by the rotor,
a nacelle (4) housing the generator,
a floatable foundation (5),
a mast section (6),
electrolysis equipment (9) for producing hydrogen from a water mass (10) upon which the floatable foundation is floating during use,
water treatment equipment (11) for preparing water from the water mass for use in the electrolysis equipment, and
one or more storage vessels (12) for storing the hydrogen, arranged below a waterline (13) of the water mass for providing buoyancy to the floatable wind turbine, wherein a storage pressure of the hydrogen in the one or more storage vessels is 2-30 bar.

### BACKGROUND OF THE INVENTION

The present invention relates to a floatable wind turbine for producing hydrogen. More in particular, the present invention relates to a floatable wind turbine, comprising:
a rotor,
a generator driven by the rotor for producing electrical power,
a nacelle housing the generator,
a floatable foundation,
a mast section having a lower end connected to the floatable foundation and an upper end connected to the nacelle,
electrolysis equipment for producing hydrogen from a water mass upon which the floatable foundation is floating during use, wherein the electrolysis equipment is powered by the electrical power from the generator,
water treatment equipment, such as desalination equipment, for preparing water from the water mass for use in the electrolysis equipment, and
one or more storage vessels for storing the hydrogen, wherein the one or more storage vessels are arranged below a waterline of the water mass for providing buoyancy to the floatable wind turbine.

Such wind turbines are known from the prior art. For instance, the company Environmental Resources Management Ltd. (ERM) has developed a concept design, called “Dolphyn” (Deepwater Offshore Local Production of HYdrogeN) for the production of hydrogen at scale from offshore floating wind. The concept situates a wind turbine, desalination unit and electrolysis equipment onto a single floating substructure to produce hydrogen that can be transported to shore via pipeline. The concept indicates that hydrogen storage will be within a separate structure on deck.

U.S. Pat. No. 7,471,010 B1 furthermore discloses a wind turbine tower assembly for storing compressed gas, such as hydrogen. The wind turbine tower includes in-tower storage configured for storing the pressurized gas. The wind turbine, however, is not configured for use as a floatable wind turbine.

Furthermore, the conference paper “Evaluating a New Concept for Integrating Compressed Air Energy Storage in Spar-type Floating Offshore Wind Turbines”, by T. Sant, D. Buhagiar and R. N. Farrugia in “Proceedings of Offshore Energy and Storage 2017”, Cape Cod, Massachusetts, USA, Jul. 12-14, 2017 presents a concept for integrating compressed air energy storage into spar-type floating wind turbine platforms. A preliminary investigation of the implications of integrating the proposed concept on the design and dynamic characteristics of a 5 MW floating offshore wind turbine (FOWT) system is presented. A parametric analysis is undertaken to establish the relationship between the energy storage capacity (when energy is stored in the form of compressed air), the spar geometry and the additional mass of the floating configuration to support high air pressures.

WO 2007/009464 A1 discloses a plant for exploiting wind energy at sea, which plant comprises a number of wind turbines, one or more longitudinal beams, a support structure and means for anchoring of the plant. The longitudinal beams whereon the wind turbines are placed are mounted on the support structure, which comprises buoyancy elements, and the plant is adapted so that it can adjust depending on the direction of the wind. Thus the plant and said wind turbines may be aligned in the wind's eye. Hydrogen can be produced and stored in the buoyancy elements.

CN 103 573 545 A discloses a float-type offshore power generating platform comprising a float, an anchoring system, a power generating system, a power transmission and distribution system and an energy-storage system.

US 2020/032473 A1 furthermore discloses a maritime structure for laying the foundations of buildings, installations or wind turbines by means of gravity in a marine environment.

CN 109 915 314 A discloses a hub of a wind turbine generator, which can be manufactured with 3D printing technology.

US 2003/168864 A1 discloses a wind energy conversion system optimized for offshore application. Wind turbines are provided each including a semi-submersible hull with ballast weight that is moveable to increase the system's stability. Hydrogen may be produced and stored in a storage external to the wind energy conversion system—or transported to shore—by means of electrolysis equipment.

WO 2012/151388 A1 moreover discloses a system for harvesting, storing, and generating energy, including a subsurface structure supporting machinery to convert received energy into potential energy, store that potential energy, and at a later time convert that potential energy into electrical energy. The system includes one or more buoyant chambers that support the subsurface structure and are maintained with an internal pressure that is approximately equal to the ambient pressure at their deployed depth. The system is anchored to the seafloor with one or more mooring lines. Suspended from the subsurface structure are one or more weights that are hoisted up or lowered down by one or more winches.

A problem with the abovementioned wind turbine designs is, however, that mechanical stresses associated with storing gases in general in large diameter vessels are relatively high, therefore leading to suboptimal reliability of the wind turbine. For instance, in the latter design, air requires to be compressed to relatively high pressures by a compressor in order to store sufficient energy to be economically feasible.

Therefore, an object of the invention is to provide a floatable wind turbine, wherein the mechanical stresses on the floatable wind turbine and the hydrogen environment properties are reduced to acceptable levels to control the fatigue of the selected materials, therefore allowing the storage of hydrogen in industrially relevant volumes and ensuring operational reliability of the system.

### SUMMARY OF THE INVENTION

Thereto, the floating wind turbine according to the invention is characterized in that:
a storage pressure of the hydrogen in the one or more storage vessels is 2-30 bar.

In accordance with the present invention, a moderate storage pressure of 2-30 bar is used to store the hydrogen in the one or more storage vessels, thus omitting the need for an additional mechanical compressor. In principle, the relatively low output pressure of electrolysis equipment can be used for ensuring flow of the hydrogen into the one or more storage vessels. Consequently, mechanical stresses on the floating wind turbine as a whole are lower than would be the case if typical compression to hydrogen storage pressures of >50 bar were used. The relatively low hydrogen pressure of the internal hydrogen environment reduces the likelihood of hydrogen-assisted metal fatigue as well as the occurrence of failure points. Thus, mechanical hydrogen compressors, which are in general mechanically complex and expensive pieces of equipment, are no longer required and therefore the reliability of the whole system is drastically improved and maintenance requirements of the system are greatly reduced. Furthermore, by arranging the one or more storage vessels below the waterline, the floatable wind turbine is at the same time provided with substantial buoyancy, further decreasing the need for additional buoyancy structures. In addition, the water pressure acting on the one or more storage vessels even further decreases mechanical stresses on the walls of the one or more storage vessels by partially counteracting the internal pressure that the stored hydrogen imposes on the walls, thus results in significant materials savings versus designs where the water pressure gradient is not considered. The storage of hydrogen below the waterline, separated from the atmosphere and out of the way of surface operations, also improves the safety of hydrogen storage as very little hydrogen is in the area where people may be present for maintenance, thereby the risk of a major explosion and resulting harm to people and equipment is greatly reduced.

It should be noted that in industry hydrogen is commonly stored at pressures of between 200 and 800 bar for ease of transportation in high pressure steel or carbon composite tubes of less than 2 m in diameter. However, this approach requires expensive and complicated compression equipment and/or the use of relatively large quantities of “exotic materials” such as carbon fibre. Also, the wall thickness is proportional to the circumference which means that storing at these pressures becomes infeasible for larger diameters such as those necessary to provide buoyancy for typical floating wind turbine designs. If this approach was used in developing a floatable wind turbine which stores hydrogen within the structure these high pressures may also lead to unwanted mechanical stresses on the wind turbine due to metal fatigue, as a consequence of the cyclical nature of the filling and emptying of the storage tanks, and the increase of susceptibility to hydrogen assisted metal fatigue in steels that may be employed for storage, ultimately resulting in structural failure. Moreover, further undesirable mechanical stresses are introduced by e.g. wind and waves constantly acting on the floatable wind turbine. Therefore, only by carefully selecting the combination of the hydrogen environment conditions, the allowable mechanical stresses and material properties can a solution be found that achieves industrially relevant levels of hydrogen storage whilst maintaining the function as a floatable wind turbine.

An embodiment relates to an aforementioned floatable wind turbine, wherein the electrolysis equipment is connected to the one or more storage vessels in such a way, that an output pressure of the electrolysis equipment is used for ensuring the flow/flowing of the hydrogen into the one or more storage vessels. Preferably, the output pressure of the electrolysis equipment is solely or exclusively used for driving or flowing the produced hydrogen into the one or more storage vessels. However, this does not exclude the possibility that a non-mechanical compressor such as a metal hydride, electrochemical or adsorption/desorption compressor is used to increase the pressure to that required to ensure flow into the storage vessels. In principle, the specific electrolysis technology to be used does not matter, only the output pressure, which is preferably slightly higher than the desired hydrogen storage pressure to ensure flow. The inventor has shown the insight that modern electrolysers are generally able to output hydrogen at moderate pressures, for instance at 0-30 bar (gauge). For instance, proton exchange membrane technology has been demonstrated to output at 30 bars, whereas alkaline technology usually outputs at atmospheric pressures (around 1 bar), although pressurized alkaline technology is also available and options exist for non-mechanical compressors such as electrochemical, metal hydrides, and adsorption-desorption compression. Thus, hydrogen can be economically produced by electrolyser at moderate pressures, therefore reducing or omitting the need for mechanical compression and thus greatly increasing reliability and operability. In general, reaching higher pressures (with or without compression) means requiring more advanced equipment and therefore higher equipment and maintenance costs. With “conventional” approaches to floating wind turbines if incorporating hydrogen production, the storage vessels may operate at between 200-800 bars, as is common in industrial practice, which would lead to significant mechanical stresses on the floating wind turbine equipment which in combination with the imposed stresses of the marine environment and the stresses resulting from the wind turbine may result in the technical infeasibility of this arrangement.

An embodiment relates to an aforementioned floatable wind turbine, wherein the output pressure of the electrolysis equipment (and any associated non-mechanical compressors such as electrochemical, metal hydrides, and adsorption-desorption compression) is 2-30 bar, such as 2-15 bar, more preferably 5-30 bar, such as 5-15 bar, even more preferably 10-30 bar, such as 10-15 bar. Present-day electrolysis equipment and non-mechanical compressors are perfectly capable of reaching the abovementioned pressures, which significantly reduce mechanical stresses on the floatable wind turbine hydrogen storage vessels. At the same, the abovementioned pressures are highly suitable for storing hydrogen in the one or more storage vessels and subsequently transporting the hydrogen to an onshore location via the attached pipeline or for powering any fuel cell which may be incorporated for the purpose of supplying electrical power.

An embodiment relates to an aforementioned floatable wind turbine, wherein a storage pressure of the hydrogen in the one or more storage vessels is 2-15 bar, more preferably 5-30 bar, such as 5-15 bar, even more preferably 10-30 bar, such as 10-15 bar. Advantageously, the abovementioned, relatively low storage pressures reduce mechanical stresses on the one or more storage vessels, thus allowing for a more economical design of the one or more storage vessels and severely increasing reliability thereof.

An embodiment relates to an aforementioned floatable wind turbine, wherein the electrolysis equipment employs proton exchange membrane electrolysis (PEM), alkaline electrolysis (AE), anion exchange membrane (AEM) electrolysis or high-temperature electrolysis (HTE), such as solid oxide electrolysis (SOE). The aforementioned electrolysis technologies in practice appear to be highly capable of producing the desired output pressures for flowing the hydrogen into the one or more storage vessels without additional compression.

An embodiment relates to an aforementioned floatable wind turbine, wherein the floatable foundation comprises a central, vertically extending structural element, during use positioned below a waterline of the water mass, having a vertical direction and a circumferential direction in a horizontal plane, wherein the one or more storage vessels comprise multiple, vertically extending storage vessels circumferentially arranged around the vertically extending structural element. By having multiple, vertically extending storage vessels circumferentially arranged around the vertically extending structural element, i.e. under the waterline, stability is provided to the floatable foundation, whereas at the same time the storage vessels are relatively well protected from external harm, such as a ship ramming the floatable foundation, and in addition this design minimizes the need to store hydrogen higher in the structure where sources of ignition may exist, thus, this arrangement increases the safety of the design. Furthermore, if damage occurs to one of the storage vessels, the floatable wind turbine is still able to function, therefore increasing reliability of the floatable wind turbine as a whole. Moreover, an operator of the floatable wind turbine can in principle decide which storage vessels are to be filled or emptied, to reduce cyclical stresses and thus storage vessel fatigue.

An embodiment relates to an aforementioned floatable wind turbine, wherein the multiple, vertically extending storage vessels have a cylindrical shape with a cross-sectional diameter of 1-10 m, preferably 2-8 m, such as 2-5 m or 4-8 m. In practice, this provides an optimal balance between providing buoyancy, hydrogen storage capacity and mechanical stress, in particular hoop stress.

An embodiment relates to an aforementioned floatable wind turbine, wherein an upper end and/or a lower end of the central, vertically extending structural element and/or the multiple, vertically extending storage vessels is provided with a heave plate. Such heave plates are preferably positioned sufficiently below the waterline to be relatively isolated from wave action and stabilize the floatable wind turbine in relation to vertical movement. The floatable wind turbine may use a combined heave and mooring plate which sits above the hydrogen storage section with the one or more storage vessels. Positioning the combined mooring and heave plate at this point will mean that stresses will be transmitted mainly between the mooring lines and the upper wind turbine structure and reduce the stresses transmitted to the lower section and thus guard against hydrogen-induced metal fatigue, which is known to be exacerbated by cyclic stresses. Additional heave plates can be utilized in a mid-section of the one or more storage vessels (i.e. somewhere in between the upper and lower ends of the one or more storage vessels) and at the lower end of the central, vertically extending structural element and these also provide further stabilization and protection of the storage vessels. The stresses from the lower plates may be conducted through a preferably non-hydrogen containing central, vertically extending structural element or through reinforcing structural members which may be arranged around the circumference of the structure and thus reduce the stresses in the areas in contact with hydrogen environment to acceptable levels.

An embodiment relates to an aforementioned floatable wind turbine, wherein a lower end of the central, vertically extending structural element and/or the multiple, vertically extending storage vessels (or, in general, a lower end of a spar-type design) comprises a ballast element or separate ballast section below the one or more storage vessels, in order to keep the floatable wind turbine stable and at an optimal operational depth. This ballast may be water, heavy minerals, such as iron oxides which may be added as bulks such as powders or gravel within the structure or may be incorporated in concrete in the form of an aggregate forming the structure of the ballast element.

An embodiment relates to an aforementioned floatable wind turbine, wherein the one or more storage vessels are made of steel comprising one or more microalloying additions to suppress hydrogen assisted fatigue crack growth. Preferably, the one or more storage vessels are made of steel. However, care must be taken to ensure carbon sulfur and phosphorus content of steels are controlled at low levels and the ultimate tensile strength is not too high, and ductility is maintained.

Examples of desirable elemental compositions for steels that may be employed in the storage section, i.e. the one or more storage vessels, are shown below:

| Element | C | Si | Mn | P | S | Nb | Ti | V | Cr | Mo |
|---|---|---|---|---|---|---|---|---|---|---|
| Com- | <0.2 | <0.5 | 0-3 | <0.2 | <0.2 | 0-0.5 | 0-0.1 | 0-0.2 | 0- | 0- |
| position | | | | | | | | | 1.25 | 0.3 |
| Weight | | | | | | | | | | |
| % | | | | | | | | | | |

Steels of high hardness are more susceptible to hydrogen embrittlement making them unsuitable for hydrogen service thus it is advantageous to utilize steels that are ductile, yet tough. In welding operations special care must be taken to avoid the formation of such particularly brittle areas which may be particularly susceptible to hydrogen-assisted fatigue crack growth. The inventor has found that the use of microalloying additions to suppress crack propagation in hydrogen-exposed steels is highly advantageous in this respect.

Preferably, the one or more microalloying additions comprise niobium at a concentration of 0-300 ppm or 200-500 ppm or 400-800 ppm. Due to the use of niobium, ferrite crystal grain size becomes less than or equal to 1 μm, severely preventing the hydrogen from penetrating and “cracking open” the ferrite crystals, thereby greatly increasing mechanical reliability of the one or more storage vessels.

It has been shown that the presence of oxygen in hydrogen can suppress hydrogen-assisted fatigue crack growth in steels an thus enhance the fatigue life of steels which are contact with a hydrogen environment. Small amounts of residual oxygen are often present in hydrogen derived from electrolysis and is usually removed by means of a catalytic deoxygenator, which converts the residual oxygen to water by reacting it with hydrogen. In one embodiment the specification of the hydrogen composition is controlled by means of a monitoring and control system which maintains an oxygen concentration between 100 and 300 ppm, 50-200 ppm or 200-500 ppm oxygen content in the storage vessel. High humidity can also promote hydrogen-assisted fatigue crack growth, therefore the relative humidity may be controlled to less than 0-50% or 20-70% by means of dehumidification of the hydrogen produced by the electrolyser.

An embodiment relates to an aforementioned floatable wind turbine, wherein the floatable wind turbine has a spar-type design, preferably a cell-spar-type design. Such a cell-spar-type design allows for an optimal balance between mass and performance, helping to achieve a cost-effective solution for floating wind turbines at a moderate water depth. The reduction in mass leads to a further lowering of mechanical stresses on the floatable wind turbine, again increasing operational reliability. The cell-spar-type design also makes the structure stiffer without the need for additional framing.

An embodiment relates to an aforementioned floatable wind turbine, wherein the electrolysis equipment, electrical equipment, such as transformers, the water treatment equipment and/or energy storage equipment are arranged inside the mast section in order to protect the electrolysis equipment from external conditions, such as severe weather conditions, corrosive sea water, et cetera.

An embodiment relates to an aforementioned floatable wind turbine, wherein the electrolysis equipment, the electrical equipment, such as transformers, the water treatment equipment and/or energy storage equipment are exchangeably arranged inside the mast section in order to allow the electrolysis and other system equipment to be easily swapped out, for example when the electrolysis equipment needs replacement or service it can conveniently be replaced or transported to shore for service.

An embodiment relates to an aforementioned floatable wind turbine, wherein the electrolysis equipment, the water treatment equipment, the electrical equipment and/or the energy storage equipment are modularized and arranged in one or more 20 ft. or 40 ft. containers, skids, or similar means, wherein the containers, skids or similar are arranged, and operated, inside the mast section for allowing easy transport, for instance over the water mass, such as a sea.

An embodiment relates to an aforementioned floatable wind turbine, wherein the floatable wind turbine is configured for refuelling hydrogen-powered boats, vessels or powering offshore equipment such as offshore oil and gas installations, islands or other equipment requiring energy in the form of hydrogen. Thus, the floatable wind turbine provides a double function of producing hydrogen for transport to an onshore location, as well as producing hydrogen for offshore use, such as the refuelling of e.g. sea-going, hydrogen-powered boats or vessels or offshore equipment such as oil and gas installations, islands or other equipment requiring energy in the form of hydrogen.

An embodiment relates to an aforementioned floatable wind turbine, wherein the electrolysis equipment, the water treatment equipment, the electrical equipment and/or the energy storage equipment are arranged directly above the waterline of the water mass during use, such as within 5-20 m, for instance within 0-10 m, of the waterline. Thus, it can be easily accessed by a vessel or boat moored at the location of the floatable wind turbine for being exchanged or replaced.

An embodiment relates to an aforementioned floatable wind turbine, wherein the one or more storage vessels and/or a wall thickness of the one or more storage vessels have a tapered design in a depth direction of the water mass, thus conveniently utilizing the increase in static pressure occurring when going deeper into the water mass, leading to a further improved design and reductions in the amount of material required to construct the storage vessels. Preferably, the tapered design is selected in such a way, that the wall thickness of the one or more storage vessels corresponds to the mechanical stresses applied by the allowable internal pressure and the (sea) water pressure gradient.

An embodiment relates to an aforementioned floatable wind turbine, wherein the one or more storage vessels are made of concrete, wherein the one or more storage vessels are preferably obtained by 3D printing or other additive manufacturing techniques. Concrete may offer several advantages compared to steel, such as the absence of hydrogen-induced metal cracking in the concrete itself. The concrete may be reinforced by such as carbon fibre, rock fibres, glass fibres or steel to the point that the tensile strength of the hydrogen storage vessels is able to contain the stresses related to storing hydrogen and the stresses related to supporting the wind turbine in a dynamic environment.

An embodiment relates to an aforementioned floatable wind turbine, wherein the one or more storage vessels comprise a honeycomb structure, to provide for a strong storage vessel structure, requiring only a minimal amount of materials.

An embodiment to an aforementioned floatable wind turbine comprising a hydrogen fuel cell configured for providing electrical power to electrical floatable wind turbine equipment such as lighting, communications equipment and stand-by and start-up equipment. The fuel cell can be fuelled with hydrogen from the storage tanks allowing a continuous supply of power. The power may be produced either directly from the wind turbine or from the fuel cell and exported to offshore equipment such as oil and gas installations, islands or other equipment requiring energy in the form of electricity. In this embodiment it would be necessary to connect the floatable wind turbine to the power consumer via an electricity cable. This would allow the present invention to serve as a high-availability power source for remote communities and industrial activities.

In an embodiment the one or more storage vessels comprise a liner layer or bladder for protecting walls, in particular steel walls, of the one or more storage vessels from hydrogen exposure. The hydrogen is contained within the liner layer or bladder which contains the hydrogen gas and acts as a protective barrier layer which protects the steel from hydrogen exposure and thus reduces the susceptibility of the structure to hydrogen-assisted metal fatigue. Such a layer may be a sealing material such as a plastic, paint or a compound which preferentially traps hydrogen or other components of the contained gas on surfaces and blocks hydrogen from further ingress into the structure of any steel present in the walls of the storage vessel.

In an embodiment the one or more storage vessels have a tubular or cylindrical shape, wherein an average cylinder (outer) diameter/wall thickness ratio is 40-400, 80-320, to properly contain the hydrogen pressure.

Another aspect of the invention relates to an offshore hydrogen production system, comprising one or more aforementioned floatable wind turbines floating on the water mass, such as a sea, and being connected to one or more hydrogen transport lines for transporting the hydrogen stored in the one or more storage vessels to an onshore location. The transport lines in the section between the floatable wind turbine and sea floor are preferably to be constructed from a from a flexible material to accommodate the motion of the floating wind turbine. Due to the susceptibility of steels to hydrogen-induced metal fatigue (as mentioned in the foregoing) which is particularly exacerbated by cyclic motions it is a risk that steel-containing flexible risers, which are commonly utilised in the oil industry, may not be suitable for this. However, the transport lines preferably may use thermoplastic composite piping or similar flexible plastic based or lined pipelines, which do not suffer from hydrogen-induced metal degradation that may affect steels or form a barrier between the transported hydrogen and any steel present.

An embodiment relates to an aforementioned offshore hydrogen production system, wherein the one or more hydrogen transport lines are provided with one or more compressors configured for increasing the pressure in the one or more hydrogen transport lines. By having such external compressors, pressure can be increased for long-distance transport or for any supply need, without having to place such compressors on-board the floatable wind turbines.

Whilst calculations show that the pressure of hydrogen exported from the floatable wind turbine is sufficient to achieve an acceptable flow rate over a few kilometres in 10-15 cm diameter pipeline commonly used in the oil and gas industry, higher diameter pipelines may be required in order to carry the hydrogen over greater distances or to collect hydrogen from several floatable wind turbines as may be the case if the a field of turbines is deployed. However, for greater distances of several hundred kilometres, as may be the case if hydrogen is generated in places remote from hydrogen consumers, compression will be required to achieve acceptable flow rates. By feeding the hydrogen flow from the floatable wind turbines of a field at relatively low pressure to e.g. a centralised collection station for compression, economies of scale may be achieved in the compression step, also allowing for maintenance and backup of a complex and expensive piece of equipment to take place at a single location and reducing the number pieces of equipment with moving parts in the field, particularly on-board the floatable wind turbines, thus enhancing reliability and reducing servicing and maintenance costs.

An embodiment relates to an aforementioned offshore hydrogen production system, wherein the one or more hydrogen transport lines comprise one or more turbine export lines and one or more field export lines, with the one or more turbine export lines being connected to the one or more compressors, the one or more compressors being connected to the one or more field export lines, wherein the one or more compressors are configured for increasing the pressure in the one or more field export lines.

Preferably, pipelines for the transport of hydrogen are realized through the partial conversion of existing pipelines by allowing injection of hydrogen into existing hydrocarbon pipelines, the conversion of hydrocarbon pipelines for hydrogen service and/or the construction of new, dedicated hydrogen pipelines.

Another aspect of the invention relates to a method for producing hydrogen using an aforementioned floatable wind turbine or an aforementioned offshore hydrogen production system, comprising the steps of:
using wind to rotate the rotor during use,
driving the generator with the rotor to produce electrical power,
using the electrical power to power the electrolysis equipment, thereby producing hydrogen from the water mass upon which the floatable foundation is floating, wherein the water treatment equipment is used for preparing the water from the water mass for use in the electrolysis equipment, and
storing the hydrogen in the one or more storage vessels to provide buoyancy to the floatable wind turbine, at a storage pressure of 2-30 bar.

Another aspect of the invention relates to a transport system for transporting an aforementioned floatable wind turbine to an offshore production location, the transport system comprising a disassembled, aforementioned floatable wind turbine for being assembled at the offshore production location, the disassembled floatable wind turbine comprising:
a rotor,
a generator arranged for being connected to and driven by the rotor for producing electrical power during use,
a nacelle arranged for housing the generator,
a floatable foundation,
a mast section having a lower end arranged for being connected to the floatable foundation and an upper end arranged for being connected to the nacelle,
electrolysis equipment for producing hydrogen from a water mass upon which the floatable foundation is floating during use, wherein the electrolysis equipment is to be powered by the electrical power from the generator,
water treatment equipment for preparing water from the water mass for use in the electrolysis equipment, and
one or more storage vessels for storing the hydrogen, wherein the one or more storage vessels are configured for being arranged below a waterline of the water mass for providing buoyancy to the floatable wind turbine and for storing the hydrogen at a storage pressure of 2-30 bar.

Thus, the floatable wind turbine can be more easily transported to the offshore location due to the disassembled state, preventing possible transport damage to the floatable wind turbine, and again increasing operational reliability thereof.

### BRIEF DESCRIPTION OF THE DRAWINGS

These and other aspects of the present invention will now be elucidated further with reference to be attached drawings, wherein like components and elements are denoted with the same reference numerals. In these drawings:

FIG. 1 schematically illustrates an exemplary embodiment of a floatable wind turbine with a cell-type spar design floating on a water mass;

FIG. 2 schematically shows an interior of an exemplary embodiment of a floatable wind turbine e.g. having a cell-type spar design;

FIG. 3 schematically shows some example dimensions of a floatable foundation of a floatable wind turbine with a spar-type design;

FIG. 4 schematically shows an exemplary embodiment of a floatable wind turbine having a spar-type design;

FIGS. 5 and 6 schematically show an example hydrogen delivery system/offshore hydrogen production system and an associated hydrogen delivery scheme (including a pressure profile);

FIG. 7 schematically shows a cross-section of an exemplary embodiment of a floatable foundation having a cell-type spar design with a central structural element and six storage vessels for storing hydrogen;

FIG. 8 schematically shows a cross-section of an exemplary embodiment of a storage vessel for storing hydrogen, having a (concrete) honeycomb structure;

FIG. 9 schematically shows a cross-section of an exemplary embodiment of a storage vessel for storing hydrogen, having a concrete structure; and

FIG. 10 schematically illustrates another exemplary embodiment of a floatable wind turbine having a semi-submersible design with multiple pillars floating on a water mass.

### DETAILED DESCRIPTION OF THE FIGURES

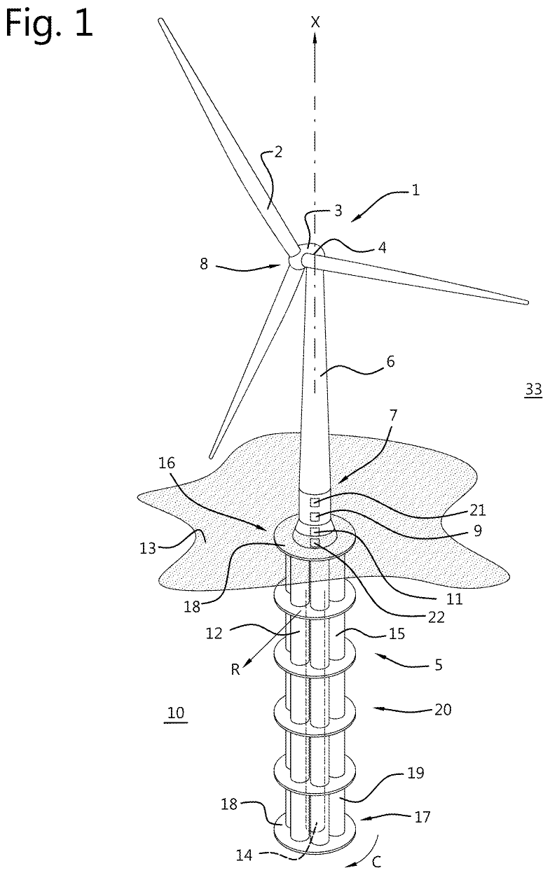

With reference to FIG. 1 an exemplary embodiment of a floatable wind turbine 1 is shown. The floatable wind turbine 1 comprises a rotor 2, a generator 3 driven by the rotor 2 for producing electrical power and a nacelle 4 housing the generator. A mast section 6 is shown having a lower end 7 connected to a floatable foundation 5 and an upper end 8 connected to the nacelle 4. In a lower end 7 region of the mast section 6 and/or an upper end 16 region of the floatable foundation 5 electrolysis equipment 9 is provided (highly schematically indicated) for producing hydrogen from a water mass 10, such as an ocean or sea, upon which the floatable foundation 5 is floating during use. The floatable foundation 5 may have a spar-type design 20, in particular a cell-type spar design 20 as shown in FIG. 1. The electrolysis equipment 9 is powered by the electrical power from the generator 3. Electrical equipment/power conditioning equipment 21, such as transformers, provides power for all equipment, in particular the electrolysis equipment 9, at correct voltage and power characteristics, e.g. DC power at a specified voltage. Further power storage equipment (battery or capacitors)(not shown) may be provided to store enough energy to power ancillary loads (lighting, control and monitoring equipment, stand-by and start-up power, et cetera). Water treatment equipment 11, such as desalination equipment, is provided for preparing water from the water mass 10, such as seawater, for use in the electrolysis equipment 9, i.e. the water treatment equipment 11 provides pure water at the specification required for efficient running of the electrolysis equipment 9. Preferably, the electrolysis equipment 9 is sized at the maximum output of the generator 3, minus any losses incurred for power conditioning. Preferably, the electrolysis equipment 9 produces hydrogen at a pressure exceeding the maximum storage pressure of the hydrogen in the one or more storage vessels 12. The hydrogen in the electrolysis equipment 9 is preferably dehumidified and the level of residual oxygen is reduced to the level required to suppress hydrogen-assisted metal fatigue. Six storage vessels 12 (or cells 12, tanks 12 or the like) are provided for storing the hydrogen. Energy storage equipment 22 aids with storing the produced hydrogen in the one or more storage vessels 12. The storage vessels 12 and/or a wall thickness of the one or more storage vessels 12 may have a tapered design in a depth direction (−X) of the water mass 10. The storage vessels 12 may have a tubular or cylindrical shape. In such a case, the average cylinder (outer) diameter/wall thickness ratio preferably is 40-400, preferably 80-320 (in particular when the storage vessels 12 are made of steel). The tubular or cylindrical storage vessels 12 are preferably smooth to reduce the tendency for developing crack-initiation spots, e.g. at welds. Other amounts of storage vessels 12 are also conceivable, such as 3, 4, 5, 7, 8, 9, 10, 18 or even more. The storage vessels 12 are arranged below a waterline 13 of the water mass 10 for providing buoyancy to the floatable wind turbine 1. The storage pressure of the hydrogen in the one or more storage vessels is 2-30 bar. Preferably, the electrolysis equipment 9 is connected to the storage vessels 12 in such a way, that an output pressure of the electrolysis equipment 9 is (primarily or exclusively) used for flowing the hydrogen into the storage vessels 12. Thereto, preferably, the output pressure of the electrolysis equipment 9 is 2-30 bar, such as 2-15 bar, more preferably 5-30 bar, such as 5-15 bar, even more preferably 10-30 bar, such as 10-15 bar. Preferably, the storage pressure of the hydrogen in the storage vessels 12 is 2-15 bar, more preferably 5-30 bar, such as 5-15 bar, even more preferably 10-30 bar, such as 10-15 bar. The electrolysis equipment 9 may employ proton exchange membrane electrolysis (PEM), alkaline electrolysis (AE), anion exchange membrane (AEM) electrolysis or high-temperature electrolysis (HTE), such as solid oxide electrolysis (SOE), depending on operational requirements.

The example floatable foundation 5 as shown in FIG. 1 comprises a central, vertically extending structural element 14, during use positioned below the waterline 13 of the water mass 10. The central structural element 14 (or in general the floatable foundation 5) has a vertical direction X and a circumferential direction C in a horizontal plane.

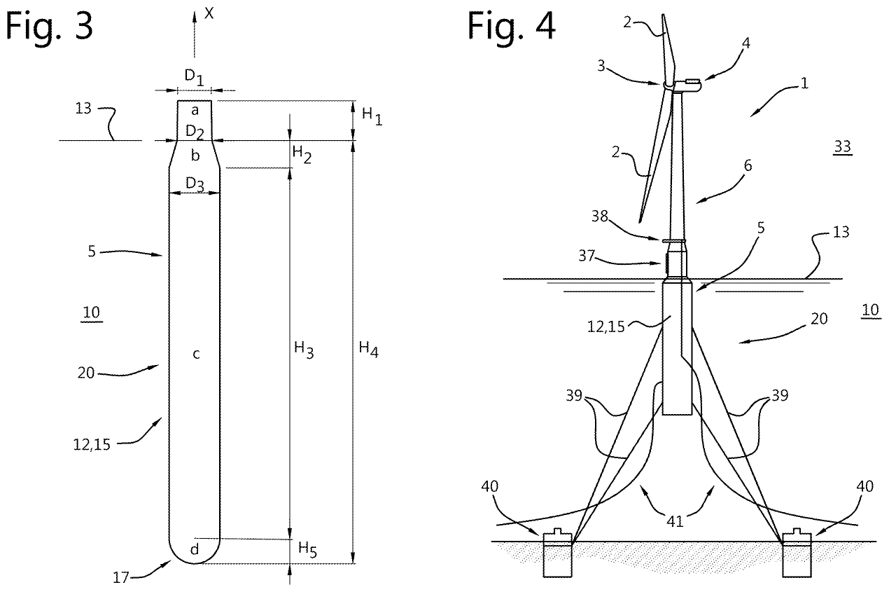

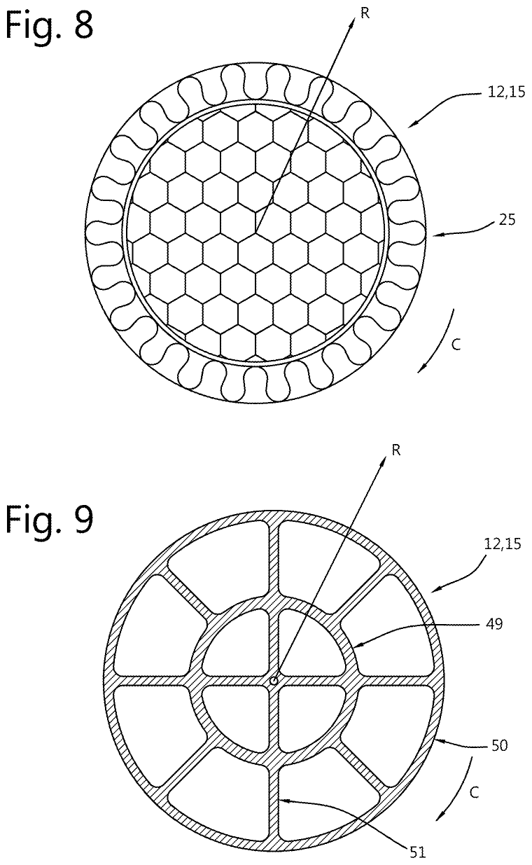

As more clearly shown in FIG. 3, a spar-type design 20 (for instance comprising a storage vessel 12 having multiple cells, as depicted in FIGS. 8 and 9—or, depending on definition, a spar-type design 20 having multiple cells or storage vessels 12), for instance having a cylindrical shape, may have a height H1+H4 (i.e. sections a, b, c and d combined) of for instance 150-200 m, such as 170-175 m. Therein, H1 (i.e. section a) may be 10-20 m, such as 15 m. H4 (i.e. sections b, c and d combined) could be 150-160 m. H2 (section b) could be 5-20 m, such as 10 m. H3 (section c) could be 120-150 m, such as 135 m. H5 (section d) could be 5-15 m, such as 10 m. Section d is preferably rounded, preferably having a hemispherical shape. Sections a and b are preferably tapered, decreasing in width/cross-section in the longitudinal direction X. Preferably, the diameter D3 (section c) is about 15-20 m, such as 18-19 m. Preferably, diameter D1 (smallest cross-section of section a is about 10-15 m, such as 12-13 m. Preferably, diameter D2 (where tapered section b connects to tapered section a) is about 10-15 m, such as about 13 m.

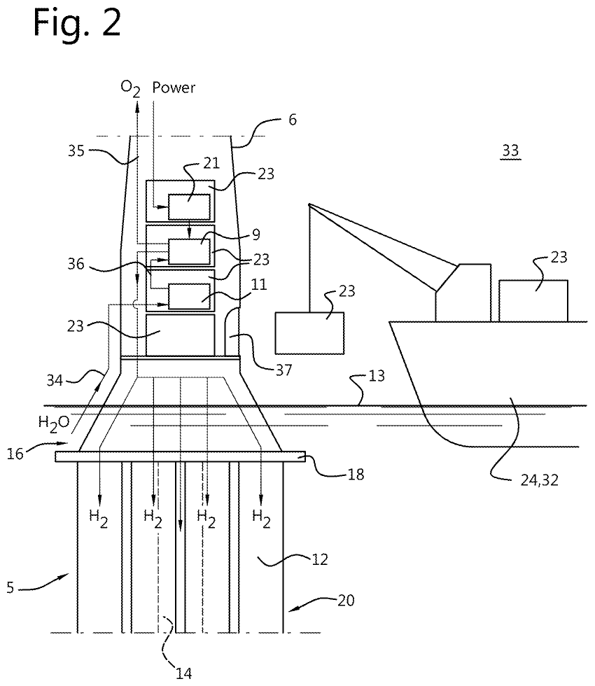

Referring to FIGS. 1 and 2, the storage vessels 12 may comprise vertically extending storage vessels 15 circumferentially arranged around the vertically extending structural element 14. Preferably, the, vertically extending storage vessels 15 have a cylindrical shape with a cross-sectional diameter of 1-10 m, preferably 2-8 m, such as 2-5 m or 4-8 m.

An upper end 16 and/or a lower end 17 of the central, vertically extending structural element 14 and/or the vertically extending storage vessels 15 may be provided with a heave plate 18. Heave plates 18 may also be provided at vertically intermediate positions, as shown in FIG. 1. A lower end 17 of the central, vertically extending structural element 14 and/or the, vertically extending storage vessels 15 may comprise a ballast element 19.

The vertically extending structural element 14 and/or the vertically extending storage vessels 12, 15 may furthermore be provided with one or more reinforcement elements (not shown), such as externally arranged reinforcement elements, for instance helical strakes, truss structures, et cetera. Such reinforcement elements may be arranged vertically between (lower/upper/intermediate) heave plates 18.

The storage vessels 12 are preferably made of steel comprising one or more microalloying additions to suppress crack propagation. The one or more microalloying additions may comprise niobium at a concentration of 100-300 ppm or 200-500 ppm or 400-800 ppm.

As shown in FIG. 2, the electrolysis equipment 9, electrical equipment 21, such as transformers, the water treatment equipment 11 and/or energy storage equipment 22 are preferably arranged inside the mast section 6 or the upper end 16 of the vertical structural element 14. More preferably, the electrolysis equipment 9, electrical equipment 21, the water treatment equipment 11 and/or energy storage equipment 22 are preferably exchangeably arranged inside the mast section 6 or the upper end 16 of the vertical structural element 14.

Furthermore, the electrolysis equipment 9, the water treatment equipment 11, the electrical equipment 21 and/or the energy storage equipment 22 may be arranged in one or more 20 ft. or 40 ft. containers or skids 23, wherein the containers or skids 23 are arranged, and operated, inside the mast section 6. The containers 23 could be stacked on top of each other as shown in FIG. 2. A vessel 24 may exchange a container 23 with “broken” or non-operational equipment, or equipment in need of servicing 9, 11, 21 and/or 22 for a container 23 with operational equipment 9, 11, 21, 22, allowing for easy repairs and minimal downtime. An access or boat landing 37 may be provided in the lower end 7 of the mast section 6 or the upper end 16 of the vertical structural element 14 for allowing access to the interior of the wind turbine 1, and the equipment 9, 11, 21, 22. The vessel 24 itself could in principle be hydrogen-powered. The vessel 24 thus can advantageously refuel using the hydrogen stored in the storage vessels 12 of the floatable wind turbine 1. Such a vessel 24 could also be used, when properly configured, to transport a disassembled floatable wind turbine 1 form an onshore location to an offshore location 33.

A water supply line 34 is furthermore shown in FIG. 2 for transporting water to the water treatment equipment 11. The treated water is then transported to the electrolysis equipment 9 for being separated into water and oxygen. An oxygen vent line 35 is provided for expelling the oxygen. The hydrogen is transported to the storage vessels 12 below the waterline 13 through one or more hydrogen lines 52.

Preferably, the electrolysis equipment 9, the water treatment equipment 11, the electrical equipment 21 and/or the energy storage equipment 22 are arranged directly above the waterline 13 of the water mass 10 during use, such as within 0-15 m, for instance within 0-10 m, of the waterline 13, allowing proper access by the vessel via a port in the side of the structure 24.

As mentioned before, preferably, the floatable wind turbine 1 is configured for refuelling hydrogen-powered boats or vessels 24.

Hydrogen may be produced and stored with the floatable wind turbine 1 by carrying out the steps of:
using wind to rotate the rotor 2 during use,
driving the generator 3 with the rotor 2 to produce electrical power,
using the electrical power to power the electrolysis equipment 9, thereby producing hydrogen from the water mass 10 upon which the floatable foundation 5 is floating, wherein the water treatment equipment 11 is used for preparing the water from the water mass 10 for use in the electrolysis equipment 9, and
storing the hydrogen in the storage vessels 12 to provide buoyancy to the floatable wind turbine 1, at a storage pressure of 2-30 bar.

As shown in FIG. 4, the floatable wind turbine may have a spar-type design, such as a cell-type spar design 20 (as more clearly shown in FIGS. 1 and 2). Suction caissons 40 may be used to anchor the floatable wind turbine 1, more specifically the floatable foundation 5, to e.g. the seabed. Several mooring lines 39 may be utilized to connect the floatable foundation 5 to the suction caissons 40. Hydrogen lines 41 are installed to transport hydrogen from the floatable wind turbine 1. If required, submarine power cables 41 may be installed in addition to or to replace (some of) the hydrogen lines 41. Again, an access or boat landing 37 is shown for allowing access to the interior of the floatable wind turbine 1 from a vessel or the like. Above the access 37 a platform 38 is furthermore shown.

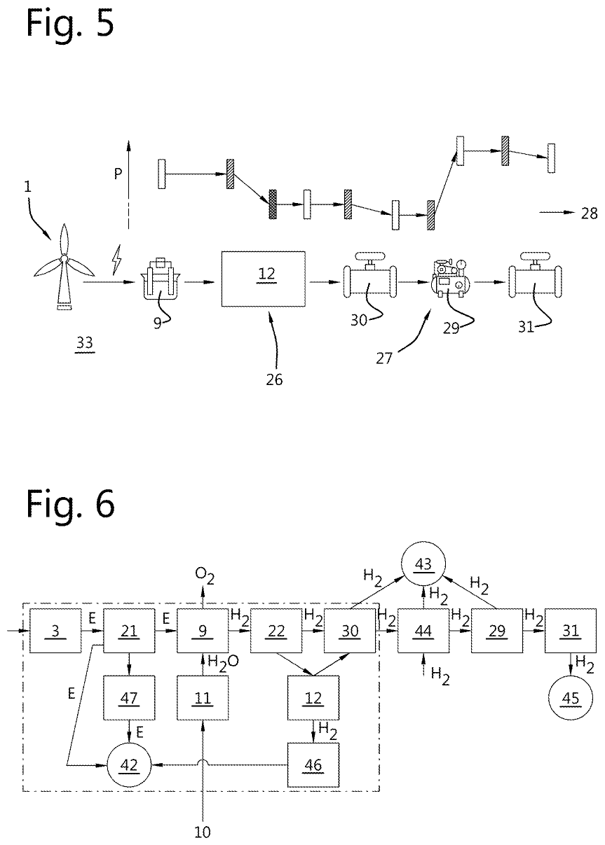

FIGS. 5 and 6 schematically show an offshore hydrogen production/delivery system 26 and a hydrogen delivery scheme, respectively, comprising one or more floatable wind turbines 1 floating on the water mass 10 and being connected to one or more hydrogen transport lines 27 for transporting the hydrogen stored in the storage vessels 12 to an onshore location 28. Preferably, the one or more hydrogen transport lines 27 are provided with one or more compressors 29 configured for increasing the pressure in the one or more hydrogen transport lines 27. The one or more hydrogen transport lines 27 may also comprise one or more turbine export lines 30 and one or more field export lines 31, with the one or more turbine export lines 30 are connected to the one or more compressors 29, the one or more compressors 29 being connected to the one or more field export lines 31 for increasing the pressure in the one or more field export lines 31. A pressure profile with inlet, storage and outlet pressures (P) is shown to indicate relatively hydrogen pressures in the hydrogen production system 26.

FIG. 6 more specifically shows a possible hydrogen delivery scheme associated with the hydrogen delivery system 26 of FIG. 5. The generator 3 transmits electrical power to electrical (conditioning) equipment 21. The electrical equipment 11 then may transmit electrical power to power storage equipment 47 or auxiliary equipment 42, for example standby equipment or equipment used for start-up. The electrical equipment 21 may also transmit electrical power to the electrolysis equipment 9. E.g. seawater may be supplied to the water treatment equipment 11, e.g. desalination equipment, such that the water can be treated before being transported to the electrolysis equipment 9. Energy-storage equipment 22 or hydrogen conditioning equipment 22 may then prepare the produced hydrogen for being stored in the storage vessel(s) 16 (wherein the hydrogen stored in the storage vessels 12 may be used to power a fuel cell, which in turn may provide power to the auxiliary equipment 42) or prepare the produced hydrogen for being transported via a turbine export pipeline 30, e.g. for transport to local consumers 43 or for transport to field collection pipelines 44. The field collection pipelines 44 may collect hydrogen from multiple floatable wind turbines 1. The field collection pipelines 44 may transport hydrogen to local consumers 43 or to a field compressor station/compressor 29, which compresses the hydrogen for use in a field export pipeline 31 for transport to distant consumers 45. In general, piping leaving one or multiple floatable wind turbines 1 may be between 60 mm-200 mm in diameter and may feed into 150 mm-600 mm field collection 44 pipelines.

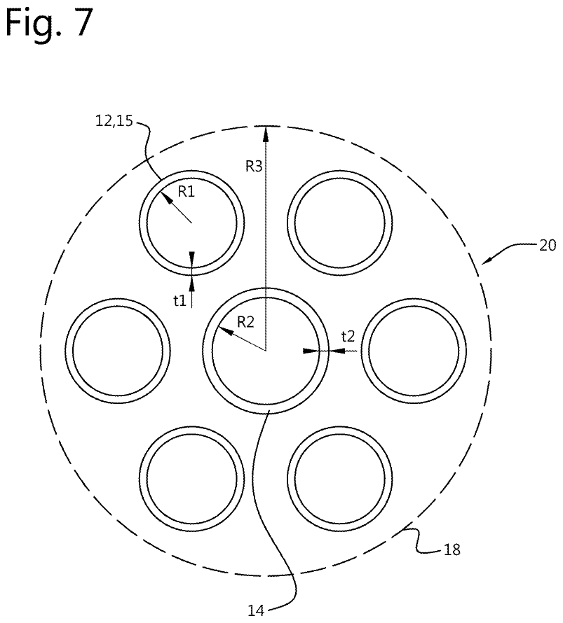

FIG. 7 schematically shows a cross-section of an exemplary embodiment of a floatable foundation having a cell-type spar design 20 with a central structural element 14 and six (vertically extending) storage vessels 12, 15 for storing hydrogen. As mentioned, one or more heave plates 18 may be provided at lower or upper ends of the storage vessels 12/central structural element 14/cell-type spar design 20 or intermediate positions in between the lower and upper ends. A wall thickness t1 of a storage vessel 12 may lie for instance between 20 and 50 mm. A wall thickness t2 of the central structural element 14 may lie for instance between 30 and 80 mm. An inner radius R1 of a storage vessel 12 could be 0.5-5 m, preferably 1-4 m, such as 1-2.5 m or 2-4 m. An inner radius R2 of the central structural element 14 could be 1-1.5 times the inner radius R1 of the storage vessel 12. A heave plate 18 radius R3 could for instance amount to 2-20 m, preferably 4-16 m, such as 4-10 m or 8-16 m.

As shown in FIG. 8, the one or more storage vessels 12, 15 in a (cell-type) spar-type design 20 (or e.g. a single storage vessel 12 in a conventional spar-type design 20), may comprise a honeycomb structure 25, allowing for a very strong yet safe storage vessel 12. The honeycomb structure 25 could be made of concrete. Such storage vessels 12 are preferably obtained by 3D printing or other additive manufacturing techniques.

As shown in the example of FIG. 9, one or more storage vessels 12, 15 could be constructed with an inner circumferential wall 49 and an outer circumferential wall 50, with radially extending walls 51 to connect the inner and outer circumferential walls 50, 51. The walls 49, 50, 51 could again be made of concrete. Of course, more/less/thicker/thinner walls can be provided, depending on operational requirements. Thus, essentially multiple storage vessels 12 or storage “cells” 12 are created, e.g. in a spar-type design 20 (as e.g. shown in FIG. 3). The cells may be provided with individual pressure control. It should be noted that, in general, also with the other embodiments shown, the one or more storage vessels, cells, tanks 12 or the like may be provided with individual pressure control. It is furthermore preferred for the floatable wind turbine 1 to be provided with a generic control system (not shown) to regulate pressures/flows between the various equipment and storage vessels 12.

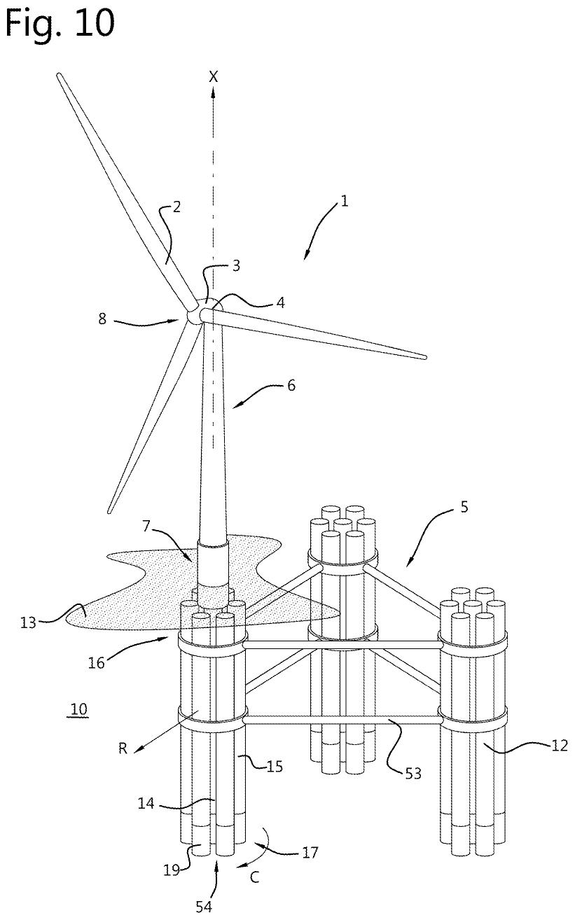

FIG. 10 schematically illustrates another exemplary embodiment of a floatable wind turbine 1 having a semi-submersible design with multiple pillars 54 (in this case three) floating on a water mass 10. Each pillar 54 may be made up of multiple hydrogen storage vessels 12, 15 in the form of hydrogen-containing cylinders, such as 1, 2, 3, 4, 5, 6, 7, 8 or even 9 cylinders. Each pillar 54 may contain 1 or more non-hydrogen-containing cylinders or structural elements 14, which may be used for water ballasting of the structure and may be reinforced in comparison with the storage vessels 12, 15 in the form of hydrogen-containing cylinders to cope with motion induced stresses. The non-hydrogen containing structural elements 14 may be provided with bracing elements 53 which join the pillars 54 so as to reduce the stresses transferred to the storage vessels 12, 15.

A “trigonal” floater concept is shown but in principle the concept may be arranged with multiple storage vessels 12, 15 in the form of hydrogen-containing cylinders arranged in pillars 54 at each corner of a triangular, square, pentagonal or hexagonal structure. Heptagonal and octagonal arrangements are also possible.

Ballast elements 19 may be attached to either the structural elements 14 or the storage elements 12, 15. Hydrogen production equipment could be contained at the transition between the upper end 16 of the structural element 14 and the lower end of the mast section 7, or on a deck constructed on the floatable foundation 5. The wind turbine 1 may be arranged either axially on one of the structural elements 14 of the pillars 54 or centrally, between the pillars 54, on a separate structural element 14 (not shown).

As mentioned with reference to FIG. 2, the vessel 24 could act as a transport system 32 for transporting the floatable wind turbine 1 to an offshore production location 33. The transport system 32 then comprises a disassembled floatable wind turbine 1 for being assembled at the offshore production location 33.

The disassembled floatable wind turbine 1 then thus comprises:
a rotor 2,
a generator 3 arranged for being connected to and driven by the rotor 2 for producing electrical power during use,
a nacelle 4 arranged for housing the generator 3,
a floatable foundation 5,
a mast section 6 having a lower end 7 arranged for being connected to the floatable foundation 5 and an upper end 8 arranged for being connected to the nacelle 4,
electrolysis equipment 9 for producing hydrogen from a water mass 10 upon which the floatable foundation is floating during use, wherein the electrolysis equipment 9 is to be powered by the electrical power from the generator 3,
water treatment equipment 11 for preparing water from the water mass 10 for use in the electrolysis equipment 9, and
one or more storage vessels 12 for storing the hydrogen, wherein the one or more storage vessels 12 are configured for being arranged below a waterline 13 of the water mass for providing buoyancy to the floatable wind turbine 1 and for storing the hydrogen at a storage pressure of 2-30 bar. Of course, some components may be transported on a separate vessel, for instance when the vessel 24 or transport system 32 has too little space onboard or is unsuitable for transporting specific components.

### LIST OF REFERENCE NUMERALS

1. Floatable wind turbine
2. Rotor
3. Generator
4. Nacelle
5. Floatable foundation
6. Mast section
7. Lower end of mast section
8. Upper end of mast section
9. Electrolysis equipment
10. Water mass
11. Water treatment equipment
12. Storage vessel for storing hydrogen
13. Waterline
14. Vertically extending structural element
15. Vertically extending storage vessel
16. Upper end of vertically extending storage vessel/structural element
17. Lower end of vertically extending storage vessel/structural element
18. Heave plate
19. Ballast element
20. Spar-type design
21. Electrical (conditioning) equipment
22. Energy-storage equipment (hydrogen)
23. Container
24. Hydrogen-powered boat/vessel
25. Honeycomb structure
26. Offshore hydrogen production system
27. Hydrogen transport line
28. Onshore location
29. Compressor
30. Turbine export line
31. Field export line
32. Transport system for transporting a floatable wind turbine
33. Offshore location
34. Water supply line
35. Oxygen vent line
36. Treated water line
37. Access to wind turbine/boat landing
38. Platform
39. Mooring line
40. Suction caisson
41. Hydrogen line/submarine power cable
42. Auxiliary power
43. Local consumers
44. Field collection pipeline
45. Distant consumers
46. Fuel cell
47. Electrical power storage equipment
48. -
49. Concrete inner wall
50. Concrete outer wall
51. Concrete radial wall
52. Hydrogen line
53. Bracing element
54. Pillar
X=Longitudinal direction
C=Circumferential direction
R=Radial direction
t1=Wall thickness of storage vessel
t2=Wall thickness of central structural element
R1=Inner radius of storage vessel
R2=Inner radius of central structural element
R3=Heave plate radius

1. Floatable wind turbine, comprising:
a rotor,
a generator driven by the rotor for producing electrical power,
a nacelle housing the generator,
a floatable foundation,
a mast section having a lower end connected to the floatable foundation and an upper end connected to the nacelle,
electrolysis equipment for producing hydrogen from a water mass upon which the floatable foundation is floating during use, wherein the electrolysis equipment is powered by the electrical power from the generator,
water treatment equipment for preparing water from the water mass for use in the electrolysis equipment,
one or more storage vessels for storing the hydrogen, wherein the one or more storage vessels are arranged below a waterline of the water mass for providing buoyancy to the floatable wind turbine, wherein
a storage pressure of the hydrogen in the one or more storage vessels is 2-30 bar.

2. Floatable wind turbine according to claim 1, wherein the electrolysis equipment is connected to the one or more storage vessels in such a way, that an output pressure of the electrolysis equipment is used for flowing the hydrogen into the one or more storage vessels.

3. Floatable wind turbine according to claim 1, wherein the output pressure of the electrolysis equipment is 2-30 bar.

4. Floatable wind turbine according to claim 1, wherein a storage pressure of the hydrogen in the one or more storage vessels is 2-15 bar.

5. Floatable wind turbine according to claim 1, wherein the electrolysis equipment employs proton exchange membrane electrolysis (PEM), alkaline electrolysis (AE), anion exchange membrane (AEM) electrolysis or high-temperature electrolysis (HTE), such as solid oxide electrolysis (SOE).

6. Floatable wind turbine according to claim 1, wherein the floatable foundation comprises a central, vertically extending structural element, during use positioned below the waterline of the water mass, having a vertical direction and a circumferential direction in a horizontal plane, wherein the one or more storage vessels comprise multiple, vertically extending storage vessels circumferentially arranged around the vertically extending structural element.

7-9. (canceled)

10. Floatable wind turbine according to claim 1, wherein the one or more storage vessels are made of steel comprising one or more microalloying additions to suppress crack propagation.

11. (canceled)

12. Floatable wind turbine according to claim 1, wherein the floatable wind turbine has a spar-type design.

13. Floatable wind turbine according to claim 1, wherein at least one of the electrolysis equipment, electrical equipment, the water treatment equipment and energy storage equipment are arranged inside the mast section.

14. Floatable wind turbine according to claim 13, wherein the at least one of the electrolysis equipment, electrical equipment, the water treatment equipment and energy storage equipment are exchangeably arranged inside the mast section.

15. (canceled)

16. Floatable wind turbine according to claim 1, wherein the floatable wind turbine is configured for refuelling hydrogen-powered boats or vessels.

17. (canceled)

18. Floatable wind turbine according to claim 1, wherein at least one of the one or more storage vessels and a wall thickness of the one or more storage vessels have a tapered design in a depth direction (−X) of the water mass.

19. Floatable wind turbine according to claim 1, wherein the one or more storage vessels are made of concrete.

20. Floatable wind turbine according to claim 1, wherein the one or more storage vessels comprise a honeycomb structure.

21. Floatable wind turbine according to claim 1, comprising a hydrogen fuel cell configured for providing electrical power to electrical floatable wind turbine equipment.

22. Floatable wind turbine according to claim 1, wherein the one or more storage vessels comprise a liner layer or bladder for protecting walls of the one or more storage vessels from hydrogen exposure.

23. Floatable wind turbine according to claim 1, wherein the one or more storage vessels have a tubular or cylindrical shape, wherein an average cylinder diameter/wall thickness ratio is 40-400.

24. Floatable wind turbine according to claim 1, wherein one or more of the of the floatable wind turbines are part of an offshore hydrogen production system, the one or more floatable wind turbines floating on the water mass and being connected to one or more hydrogen transport lines for transporting the hydrogen stored in the one or more storage vessels to an onshore location.

25-26. (canceled)

27. Method for producing hydrogen using a floatable wind turbine according to claim 1, comprising the steps of:
using wind to rotate the rotor during use,
driving the generator with the rotor to produce electrical power,
using the electrical power to power the electrolysis equipment, thereby producing hydrogen from the water mass upon which the floatable foundation is floating, wherein the water treatment equipment is used for preparing the water from the water mass for use in the electrolysis equipment, and
storing the hydrogen in the one or more storage vessels to provide buoyancy to the floatable wind turbine, at a storage pressure of 2-30 bar.

28. Transport system for transporting a floatable wind turbine according to claim 1 to an offshore production location, the transport system comprising a disassembled floatable wind turbine according to claim 1 for being assembled at the offshore production location, the disassembled floatable wind turbine comprising:
a rotor,
a generator arranged for being connected to and driven by the rotor for producing electrical power during use,
a nacelle arranged for housing the generator,
a floatable foundation,
a mast section having a lower end arranged for being connected to the floatable foundation and an upper end arranged for being connected to the nacelle,
electrolysis equipment for producing hydrogen from a water mass upon which the floatable foundation is floating during use, wherein the electrolysis equipment is to be powered by the electrical power from the generator,
water treatment equipment for preparing water from the water mass for use in the electrolysis equipment, and
one or more storage vessels for storing the hydrogen, wherein the one or more storage vessels are configured for being arranged below a waterline of the water mass for providing buoyancy to the floatable wind turbine and for storing the hydrogen at a storage pressure of 2-30 bar.
